(19) United States
(12) Patent Application Publication
(10) Pub. No.: US 2015/0348583 A1
(43) Pub. Date: Dec. 3, 2015

(54) DISK DRIVE DEVICE

(71) Applicant: SAMSUNG ELECTRO-MECHANICS JAPAN ADVANCED TECH. CO. LTD., Fujieda City (JP)

(72) Inventors: Mikie KUMAKI, Fujieda City (JP); Hiroshi IWAI, Fujieda City (JP)

(73) Assignee: SAMSUNG ELECTRO-MECHANICS JAPAN ADVANCED TECH. CO. LTD., Fujieda City (JP)

(21) Appl. No.: 14/723,986

(22) Filed: May 28, 2015

(30) Foreign Application Priority Data
May 29, 2014 (JP) 2014-111343

(51) Int. Cl. G11B 19/20

(52) U.S. Cl. CPC G11B 19/2036

(57) ABSTRACT

A disk drive device of the present disclosure includes a hub including a cylindrical portion with which a recording disk is to be engaged, and fixed with an annular magnet, a base including a support which supports a stator core including coils, and, a bottom which is integral with the support and which faces the coils in an axial direction, a fluid bearing mechanism supporting the hub in a manner freely rotatable relative to the base, and an annular member fixed to an inner circumference of the cylindrical portion of the hub and including a first part that is present in an area where the base and the magnet face with each other.

### BACKGROUND OF THE INVENTION

1. Field of the Invention

The present disclosure relates to a disk drive device.

2. Description of the Related Art

JP 2009-136143 A, U.S. Pat. No. 7825557, JP 2010-286071 A, and JP 2012-087867 A disclose disk drive devices, such as a hard disk drive, equipped with a fluid dynamic bearing applied with a fluid between, for example, an axial member and a bearing member.

As to disk drive devices, in order to load a large number of recording disks on a rotating body, the bearing span of the fluid dynamic bearing may be elongated to increase the bearing rigidity.

According to the above-explained disk drive devices, when the bearing span is elongated, a fluid passage provided in the bearing member also increases the dimension in the axial direction (see, for example, JP 2009-136143 A). When, for example, the fluid passage is formed by drilling, if the fluid passage is long, it is necessary to apply a thin and long drill bit. However, a thin and long drill bit is likely to be broken in comparison with a short drill bit. Hence, it is necessary to carry out the drilling work slowly and carefully. Consequently, the drilling work for along fluid passage may remarkably decrease the manufacturing efficiency. When, in particular, the bearing member is formed of a harder material than a non-ferrous metal like stainless steel, the reduction of the manufacturing efficiency becomes prominent.

A fluid passage to be formed may be thin using a thin drill bit, but in this case, the resistance in the fluid passage becomes small, and thus the mass of a fluid held in the fluid passage increases. Consequently, when shock is applied, the fluid to which this shock is applied is likely to spill out to the exterior. In addition, a structure having no fluid passage is possible, but according to this structure, a pressure difference in a fluid holding space becomes large depending on the manufacturing error, and the fluid may be pushed out to the exterior due to such a pressure difference.

The present disclosure has been made in view of the aforementioned circumstances, and it is an objective of the present disclosure to provide a disk drive device which has an elongated bearing span of a fluid dynamic bearing, and which has also an increased bearing rigidity.

### SUMMARY OF THE INVENTION

To accomplish the above objective, a disk drive device according to a first aspect of the present disclosure includes:

a hub which includes a cylindrical portion with which a recording disk is to be engaged, and which is fixed with an annular magnet;

a base that includes a support which supports a stator core including coils, and, a bottom which is integral with the support and which faces the coils in an axial direction;

a fluid bearing mechanism that supports the hub in a manner freely rotatable relative to the base; and

an annular member which is fixed to an inner circumference of the cylindrical portion of the hub and which includes a first part that is present in an area where the base and the magnet face with each other.

To accomplish the above objective, a disk drive device according to a second aspect of the present disclosure includes:

a hub which includes a cylindrical portion with which a recording disk is to be engaged, and which is fixed with an annular magnet; and

an annular member that includes an annular first part fixed to an inner circumference of the cylindrical portion of the hub, and, an abut part abutting the magnet, the first part and the abut part being integral with each other.

By employing the above-explained structure, the disk drive device of the present disclosure can have an elongated bearing span of a fluid dynamic bearing, and also an increased bearing rigidity.

### BRIEF DESCRIPTION OF THE DRAWINGS

FIG. 1 is an exploded perspective view of a disk drive device according to an embodiment of the present disclosure;

FIG. 2 is a cross-sectional view taken along a line A-A in FIG. 1;

FIG. 3 is an enlarged cross-sectional view illustrating a fluid passage in FIG. 2 in an enlarged manner;

FIG. 4 is an enlarged cross-sectional view illustrating a modified example of the fluid passage in an enlarged manner;

FIG. 5 is an enlarged cross-sectional view illustrating another modified example of the fluid passage in an enlarged manner;

FIG. 6 is an enlarged cross-sectional view illustrating an annular member in FIG. 2 in an enlarged manner;

FIG. 7 is an exploded diagram illustrating a part of an inner circumference of a shaft encircling member; and

FIG. 8 is an enlarged perspective view illustrating a part of stripe-pattern grooves in FIG. 7 in an enlarged manner.

### DETAILED DESCRIPTION OF THE PREFERRED EMBODIMENTS

Preferred embodiments of the present disclosure will be explained below with reference to the figures. The same or equivalent structural element and member will be denoted by the same reference numeral in respective figures, and the duplicated explanation will be omitted accordingly. In addition, the dimension of each member in each figure is shown in an enlarged or scaled-down manner as needed to facilitate understanding to the present disclosure. A part of a member not important to explain the embodiment of the present disclosure will be omitted in each figure.

A disk drive device according to an embodiment is suitably utilized as, for example, a hard disk drive on which a magnetic recording disk that records data magnetically is to be mounted, and which rotates and drives such a disk. This disk drive device may include a rotating body that is attached to a stationary body in a freely rotatable manner through a beating mechanism. This rotating body may include a mounting mechanism on which a drive-target medium like the magnetic recording disk is to be mounted. The bearing mechanism contains, for example, a lubrication fluid, and generates dynamic pressure to the lubrication fluid. This bearing mechanism may include a radial bearing mechanism and a thrust bearing mechanism which are formed in either the stationary body or the rotating body. The thrust bearing mechanism may be disposed outwardly in the radial direction relative to the radial bearing mechanism. This disk drive device may include a rotation/drive mechanism that applies rotation torque to the rotating body. This rotation/drive mechanism may be, for example, a brushless spindle motor. This rotation/drive mechanism may include a coil and a magnet.

### Embodiment

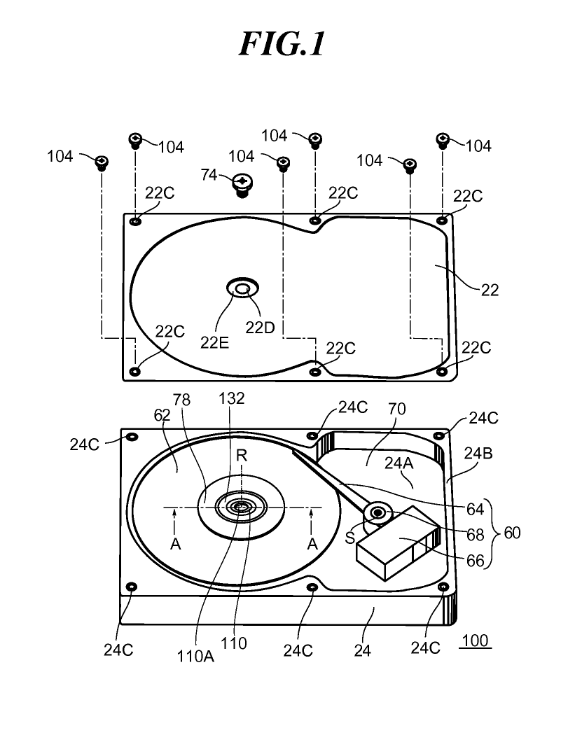

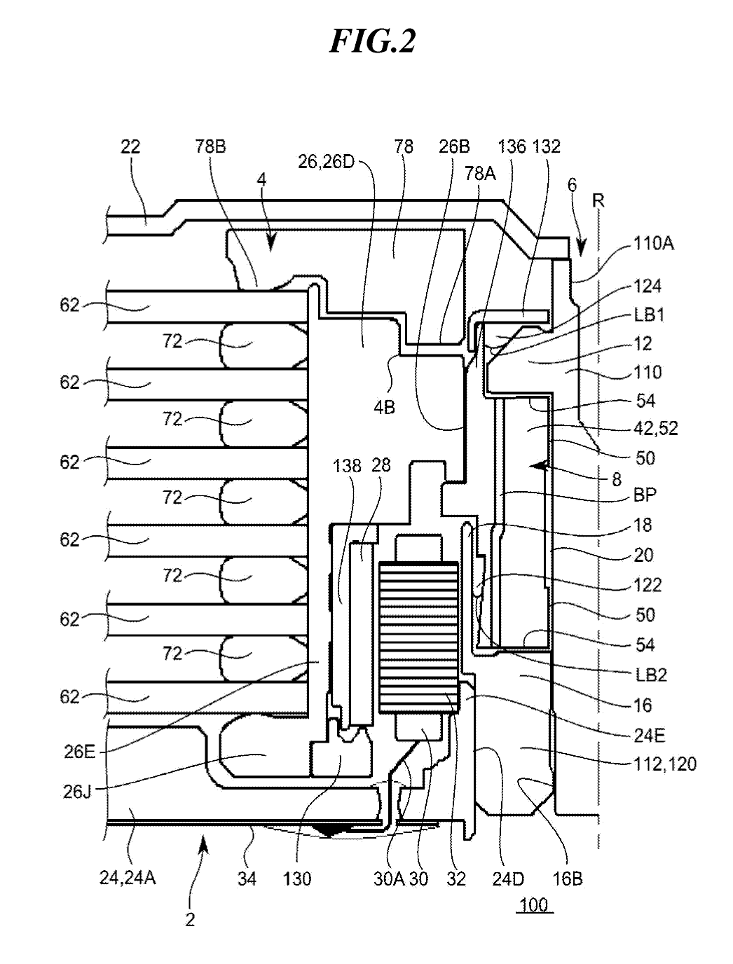

An explanation will be given with reference to FIGS. 1 to 8. A member not important to explain the present disclosure is omitted in FIGS. 1 to 8. FIG. 1 is a perspective view illustrating a disk drive device 100 according to this embodiment. In order to facilitate understanding to the present disclosure, in FIG. 1, a top cover 22 is detached. FIG. 2 illustrates a left side relative to a rotation axis R, and is a cross-sectional view taken along a line A-A in

FIG. 1. In order to facilitate understanding to the present disclosure, in FIG. 2, the top cover 22 is mounted, but a center screw 74 is not attached yet.

The disk drive device 100 includes a chassis 24, a shaft 110, a hub 26 (unillustrated in FIG. 1), magnetic recording disks 62, a cap 132, a clamper 78, a data reader/writer 60, the top cover 22, the center screw 74, and for example, six peripheral screws 104.

In the following explanation, a side at which the hub 26 is provided relative to the chassis 24 is defined as an upper side. In addition, a direction along the rotation axis R of a rotating body is defined as an axial direction, an arbitrary direction passing through the rotation axis R on a vertical plane thereto is defined as a radial direction, and an arbitrary direction on that plane is defined as a planar direction in some cases. Those definitions do not limit the posture of the disk drive device 100 when in use, and the disk drive device 100 can be used in an arbitrary posture.

The magnet recording disk 62 is, for example, a 3.5-inch magnetic recording disk which is formed of an aluminum alloy and which has a diameter of substantially 90 mm. For example, the six magnetic recording disks 62 are to be mounted on the hub 26, and are rotated together with the rotation of the hub 26. The magnetic recording disks 62 are fastened to the hub 26 by spacers 72 and a clamper 78. The clampers 78 and the spacer 72 will be explained in more details later.

The chassis 24 includes a bottom part 24A that forms the bottom of the disk drive device 100, and an outer circumference wall part 24B. For example, six screw holes 24C are provided in the top face of the outer circumference wall part 24B. The chassis 24 may be referred to as a base in some cases.

The data reader/writer 60 includes a recording/playing head (unillustrated), a swing arm 64, a voice coil motor 66, and a pivot assembly 68. The recording/playing head is attached to the leading end of the swing arm 64, reads data from the magnetic recording disk 62, or writes data therein. The pivot assembly 68 supports the swing arm 64 so as to be swingable relative to the chassis 24 around a head rotation axis S. The voice coil motor 66 swings the swing arm 64 around the head rotation axis S to move the recording/playing head to a desired location over the top face of the magnetic recording disk 62. The voice coil motor 66 and the pivot assembly 68 are constructed by conventionally well-known technologies that control the head position.

The top cover 22 is a thin plate formed in a substantially rectangular shape, and includes, for example, six screw through-holes 22C provided at the peripheral areas, a cover protruding part 22E that protrudes downwardly toward the chassis, and a center hole 22D provided at the center of the cover protruding part 22E. The cover protruding part 22E is provided around the rotation axis R. The top cover 22 is formed of, for example, an aluminum plate or a steel plate which is subjected to pressing into a predetermined shape. The top cover 22 may include, for example, a surface layer like plating. The top cover 22 is fixed to the top face of the outer circumference wall part 24B of the chassis 24 using, for example, the six peripheral screws 104. The six peripheral screws 104 correspond to the respective six screw through-holes 22C, and the respective six screw holes 24C. In particular, the top cover 22 and the top face of the outer circumference wall part 24B are fixed with each other. Provided inside the disk drive device 100 is a disk retaining space 70 that is defined by the bottom part 24A of the chassis 24, the outer circumference wall 24B thereof, and the top cover 22. This disk retaining space 70 is air-tightly sealed, and is filled with a clean gas like helium. The top cover 22 allows the center screw 74 to pass completely through the center hole 22D, and to be engaged with and fastened to a retaining hole 110A, and thus the top cover 22 is joined with the shaft 110.

FIG. 2 is a diagram illustrating the left side relative to the rotation axis R and is a cross-sectional view taken along a line A-A in FIG. 1. A stationary body 2 includes a shaft body 6, a stator core 32, coils 30, and a flexible printed board 34. The shaft body 6 includes the shaft 110, a top flange 12 that is fixed to the one-end side of the shaft 110, and a thrust cup 112 that is fixed to the other-end side of the shaft 110. A rotating body 4 includes the hub 26, a bearing body 8, an annular member 130, a cap 132, a yoke 138, and a magnet 28. The rotating body 4 and the stationary body 2 include a lubrication fluid that is a lubricant 20 continuously present in some gaps between the shaft body 6 and the bearing body 8. The bearing body 8 includes a shaft encircling member 42 that encircles the shaft 110 with a gap.

The shaft encircling member 42 is fixed to the hub 26. In addition, the shaft body 6, the bearing body 8, and the lubricant 20 construct a bearing mechanism 52 together with dynamic pressure generating grooves to be discussed later.

### Chassis

The chassis 24 is integrally formed by, as an example, die-cast molding of an aluminum alloy. The chassis 24 may be formed by, for example, pressing of a sheet metal, such as stainless steel or aluminum. In this case, the chassis 24 includes an embossed surface partially embossed by pressing. The chassis 24 may include a surface treatment layer, such as a plating layer of nickel or a resin coating layer of an epoxy resin. In addition, the chassis 24 may have a part formed of a resin. The chassis 24 may have the bottom part 24A formed by equal to or greater than two laminated plates.

The chassis 24 includes a protruding part 24E that is cylindrical as viewed from the top around the rotation axis R, and a bearing hole 24D which passes completely through the center of the protruding part 24E and extends in the axial direction. The protruding part 24E protrudes toward the hub 26 from the upper face of the bottom part 24A. The top face of the protruding part 24E faces the thrust cup 112 in the axial direction. The inner circumference of the bearing hole 24D is formed in a cylindrical shape as viewed from the top around the rotation axis R. A part of the shaft body 6 of the bearing mechanism 52 is fitted in and fixed with the inner circumference of the bearing hole 24D. The bearing hole 24D may be a non-through hole with a plugged bottom.

### Stator Core

The stator core 32 includes an annular part, and for example, 12 salient poles that extend from the annular part in the radial direction. The stator core 32 is formed by, for example, five to 35 laminated magnetic steel sheets each having a thickness of 0.2 to 0.35 mm and integrated together by crimping. In this embodiment, as an example, 17 magnetic steel sheets each having a thickness of 0.2 mm are laminated together. A surface layer, such as electro-deposition painting layer or a powder painting layer, is formed on the surface of the stator core 32. The stator core may be a so-called solid core formed of magnetic powders bound in a predetermined shape.

The stator core 32 has the lower end of the annular part at the inner circumference side fitted with and seated on a step provided at the outer circumference of the protruding part 24E. The stator core 32 has the inner circumference of the annular part joined with the step of the protruding part 24E by press-fitting, bonding or a combination thereof. The stator core 32 has the inner circumference of the annular part bonded and fixed to the outer circumference of a flange encircling part 18 of the thrust cup 112 by a bond. In this embodiment, 50 to 90% of the inner circumference of the annular part of the stator core 32 is included in a fixedly supported joint area. In this case, vibration of the stator core 32 can be further suppressed. The bond to fix the stator core 32 may contain a fluorescent material.

### Coils

The coils 30 are a wire wound around each salient pole of the stator core 32 by a predetermined number of turns. The wire is formed by, for example, covering the surface of a conductor core wire like soft copper by an insulation layer of an urethane resin. A lubrication substance like a polyamide compound may be applied to the surface of the wire. A drawn line 30A of the coils 30 is electrically connected with a wiring conductor of the flexible printed circuit board 34 provided on the bottom face of the bottom part 24A of the chassis 24. When a drive current flows through the coils from an unillustrated drive circuit through the flexible printed circuit board 34, field magnetic fields are generated along the respective salient poles.

### Hub

The hub 26 includes, all in an annular shape as viewed from the top around the rotation axis R, a disk part 26D, an engage part 26E, and a mount part 26J. The hub 26 is formed by, for example, cutting and machining a non-ferrous material like an aluminum alloy or an iron and steel material like stainless steel. The disk part 26D extends in the radial direction, and is provided with, at the center, an opening 26B passing completely through in the axial direction. The engage part 26E extends from the lower part of the outer circumference of the disk part 26D downwardly in the axial direction, and has the cylindrical outer circumference to be engaged with the center hole of the magnetic recording disk 62. The mount part 26J extends from the lower part of the outer circumference of the engage part 26E outwardly in the radial direction, and the lowermost magnetic recording disk 62 is to be mounted on this mount part 26J. The hub 26 has the disk part 26D, the engage part 26E, and the mount part 26J formed integrally one another.

The hub 26 may include a portion that is formed of a resin material like Liquid Crystal Polymer (LCD). The hub 26 may be provided with a surface layer, such as coating or plating. In this case, for example, the surface layer can suppress a peeling from the surface.

### Spacer

The spacer 72 is a hollow member formed in a ring shape as viewed from the top, and is formed by, for example, cutting and machining a metal material like SUS 303 (a kind of stainless steel, the same is true in the following explanation). The spacer 72 has the inner circumference engaged with the engage part 26E, and is provided between the lower magnetic recording disk 62 and the upper magnetic recording disk 62. Each spacer 72 separates the adjoining magnetic recording disks 62. The magnetic recording disks 62 are fixed to the hub 26 by the spacers 72 and the clamper 78.

### Clamper

The clamper 78 is a hollow member formed in a disk shape as viewed from the top, and is formed by, for example, cutting and machining a metal material like SUS 303. The clamper 78 includes an annular holding part 78B that extends in the axial direction from the lower end of the outer circumference of the clamper 78, and an annular extended part 78A that extends in the axial direction from the lower end of the inner circumference. The lowermost end of the extended part 78A is located below the lowermost end of the holding part 78B in the axial direction. As an example, the clamper 78 is fixed to the top face of the hub 26 by a fastener like a screw (unillustrated). The clamper 78 has the holding part 78B abutting the top face of the uppermost magnetic recording disk 62.

The clamper 78 has the extended part 78A entering a guide part 4B formed in the disk part 26D of the hub 26 as an annular recess in the axial direction. In particular, the guide part 4B has a part of the upper end of the inner circumference of the disk part 26D increasing the diameter. The clamper 78 has the extended part 78A positioned by the guide part 4B. The guide part 4B may be formed by a part of the upper end of the outer circumference of the shaft encircling member 42 of the bearing mechanism 52 which decreases the diameter instead of the hub 26.

### Yoke

The yoke 138 includes a hollow cylindrical part formed in an annular shape as viewed from the top, and an extended part that extends inwardly in the radial direction from the upper end of the cylindrical part. The yoke 138 is formed by, for example, pressing or cutting and machining of a ferrous material with soft magnetism. The yoke 138 has the outer circumference of the cylindrical part bonded and fixed to the inner circumference of the engage part 26E of the hub 26. This bond may contain a fluorescent material. The yoke 138 has the magnet 28 engaged with and bonded and fixed to the inner circumference of the cylindrical part. This bond may also contain a fluorescent material. The yoke 138 has the lower end of the extended part abutting the magnet 28, and has the upper end of the extended part abutting the hub 26. The yoke 138 may include a surface layer like plating or coating.

### Magnet

The magnet 28 is a hollow member formed in a cylindrical shape as viewed from the top, and is formed of, for example, a ferrite-based magnetic material or a rare-earth magnetic material. The magnet 28 may contain a resin like polyamide as a binder. The magnet 28 may include a surface layer like electrodeposition coating or spray painting. As an example, the magnet 28 is formed with eight or 16 magnetic polarities on the inner circumference that faces the salient poles of the stator core 32 in the radial direction. The magnet 28 has the outer circumference bonded and fixed to the inner circumference of the yoke 138. The magnet 28 may be formed as a laminated layer that includes a layer of ferrite-based magnet and a layer of rare-earth magnet. The magnet 28 may have the height dimension larger than that of the stator core 32.

### Annular Member

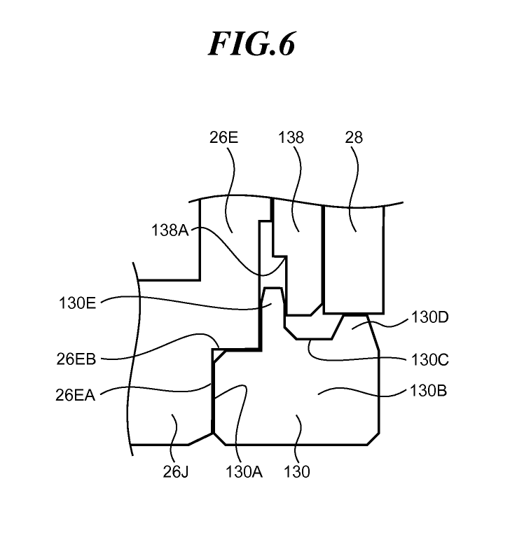

FIG. 6 is an enlarged cross-sectional view illustrating the annular member 130 in FIG. 2 in an enlarged manner. The annular member 130 is a hollow member formed in an annular shape as viewed from the top, and is formed by, for example, cutting and machining a metal material like SUS 430 (a kind of stainless steel, the same is true in the following explanation). The annular member 130 has the outer circumference part 130A engaged with and fixed to an inner circumference 26EA of the engage part 26E of the hub 26. The annular member 130 may be fixed to the engage part 26E by interference fitting. A bond may be applied between the annular member 130 and the engage part 26E. This bond may also contain a fluorescent material. The annular member 130 maybe formed of a magnetic or non-magnetic material, and may include a magnetic portion and a non-magnetic portion.

The annular member 130 may include at least either a part 130C that faces the yoke 138 in the axial direction, or a part 130B that is present in an area where the bottom part 24A of the chassis 24 and the magnet 28 face with each other in the axial direction. The annular member 130 may also include at least either a part 130D which protrudes upwardly in the axial direction from the inner circumference of the annular member 130, and which abuts the magnet 28, or a part 130E which protrudes downwardly in the axial direction from the outer circumference, and which is present between the engage part 26E and the magnet 28. The annular member 130 may further include an outer circumference part 130A which protrudes in the radial direction from the outer circumference of the annular member 130, and which is engaged with an annular step 26EB provided in the inner circumference of the engage part 26E.

### Fluid Bearing Mechanism

The shaft body 6, the bearing body 8, and the lubricant 20 further construct the bearing mechanism 52. The bearing mechanism 52 includes a thrust dynamic pressure bearing part provided in a gap between the shaft body 6 and the bearing body 8 in the axial direction, and a radial dynamic pressure bearing part provided in a gap between the shaft body 6 and the bearing body 8 in the radial direction. The bearing mechanism 52 holds the lubricant 20 in gaps between the shaft body 6 and the bearing body 8.

### Shaft Body

The shaft body 6 includes the shaft 110, the top flange 12 that is fixed to an end portion of the shaft 110 away from the chassis 24, and the thrust cup 112 fixed to the other end portion of the shaft 110.

### Shaft

The shaft 110 is a substantially cylindrical member that extends along the rotation axis R, and is formed by, for example, cutting and machining or grinding of a ferrous material, such as SUS 420 J2 (a kind of stainless steel, the same is true in the following explanation), SUS 430, or SUS 303. The shaft 110 is formed with a retaining hole 110A which is provided in an end face of the one end along the rotation axis R and which retains a fastener like the center screw 74. The shaft 110 may be quenched. The shaft 110 may have the outer circumference and the lower face of the top flange 12 polished. The shaft 110 may be formed of other materials like a resin, and may be formed by other techniques, such as pressing and molding.

### Top Flange

The top flange 12 is an annular member as viewed from the top, and is formed integrally with the shaft 110. The top flange 12 has a tapered face which is formed on the outer circumference and which increases a distance from the rotation axis R in the radial direction as coming close to the chassis 24. The top flange 12 is encircled by an outer cylinder part 136 via a gap. The top flange 12 includes a portion that faces the top face of the shaft encircling member 42 in the axial direction.

The top flange 12 may be formed as a separate piece from the shaft 110, and may then be bonded and fixed to the shaft 110. In this case, the top flange 12 can be formed by cutting and machining a ferrous material, such as SUS 430 or SUS 303.

### Thrust Cup

The thrust cup 112 is a hollow annular member that encircles the rotation axis R as viewed from the top, and is formed by cutting and machining a metal material, such as SUS 430 or brass. The thrust cup 112 includes a flange part 16, the flange encircling part 18, and a shaft ring 120. The flange part 16 protrudes from the shaft 110 in the radial direction. The shaft ring 120 protrudes downwardly from the flange part 16, and encircles the shaft 110. The flange part 16 and the shaft ring 120 are formed with a shaft insertion hole 16B along the rotation axis R. The flange encircling part 18 protrudes upwardly toward the hub 26 from the outer circumference of the flange part 16.

The thrust cup 112 has the flange part 16, the flange encircling part 18, and the shaft ring 120 formed integrally one another. The thrust cup 112 may have the flange part 16, the flange encircling part 18, and the shaft ring 120 formed separately one another, and joined together later.

The thrust cup 112 has the shaft 110 fitted in the shaft insertion hole 16B, and fastened therewith by interference fitting like press fitting. A joined portion between the shaft 110 and the thrust cup 112 may have a bond therebetween. This bond may contain a fluorescent material. The thrust cup 112 may be formed integrally with the shaft 110.

### Bearing Body

The bearing body 8 includes the shaft encircling member 42 and the outer cylinder part 136 both formed in a substantially annular shape as viewed from the top. In particular, the bearing body 8 has the upper portion of the outer circumference of the shaft encircling member 42 fixed to the opening 26B provided in the center of the hub 26 in the axial direction by thermal insertion. The shaft encircling member 42 may be fixed to the hub 26 by other techniques like press fitting. A joined portion between the bearing body 8 and the hub 26 may be applied with a bond. This bond may include a fluorescent material. The bearing body 8 may have the shaft encircling member 42 formed integrally with the hub 26.

### Shaft Encircling Member

The shaft encircling member 42 is formed by, for example, cutting and machining a metal material, such as SUS 430 or brass. The shaft encircling member 42 includes an inner circumference that encircles the shaft 110 via a gap, an upper end part that faces the lower face of the top flange 12 via a gap in the axial direction, and a lower end part that faces the top face of the flange 16 via a gap in the axial direction. The shaft encircling member 42 may be provided with a lubricant reserving space which is formed in the inner circumference and which concaves outwardly in the radial direction.

### Outer Cylinder Part

The outer cylinder part 136 protrudes upwardly in the axial direction from the shaft encircling member 42, and which encircles the top flange 12. The outer cylinder part 136 is formed integrally with the shaft encircling member 42. The outer cylinder part 136 may be formed separately from the shaft encircling member 42 and may be bonded and fixed thereto later.

### Dynamic Pressure Generating Groove

Dynamic pressure generating grooves 50 that generate radial dynamic pressure are provided in the inner circumference of the shaft encircling member 42. The dynamic pressure generating grooves 50 may be provided in the outer circumference of the shaft 110. Dynamic pressure generating grooves 54 that generate thrust dynamic pressure are provided in at least one of the lower face of the top flange 12, the upper end face of the shaft encircling member 42, the top face of the flange part 16, and the lower end face of the shaft encircling member 42.

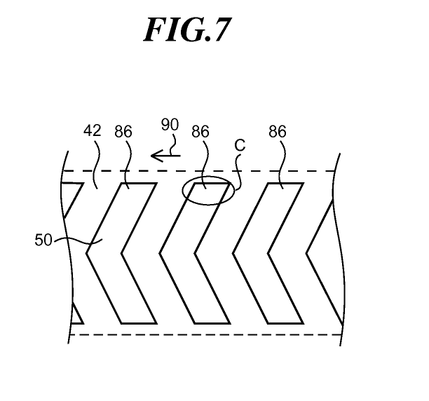

The dynamic pressure generating grooves 50 and 54 include multiple stripe grooves 86 extending in a direction slanted relative to the circumference direction and formed in a stripe shape disposed at a predetermined pitch. The dynamic pressure generating grooves 50 and 54 are formed in, as an example, a herringbone shape or a spiral shape that is a combination of the multiple stripe grooves 86. FIG. 7 is an exploded diagram illustrating an example dynamic pressure generating grooves 50 formed in the inner circumference of the shaft encircling member 42 and in a herringbone shape. An arrow 90 indicates the circumference direction. In particular, the dynamic pressure generating grooves 50 have the multiple stripe grooves 86 in a bent shape arranged side by side in the circumferential direction.

### Micro Grooves

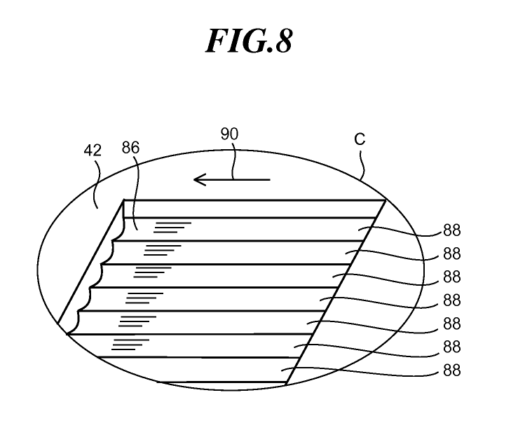

FIG. 8 is an enlarged perspective view illustrating a portion of the stripe groove 86 encircled by an ellipse C in FIG. 7. Multiple micro grooves 88 all extending in the circumferential direction are formed in the bottom of each stripe groove 86 and arranged side by side in the axial direction. The multiple micro grooves 88 have respective adjoining groove portions overlapping with each other in the axial direction. That is, the strip groove 86 is a set of the multiple micro grooves 88 having respective adjoining portions overlapping with each other in the axial direction and arranged side by side in the axial direction. The bottom of the strip groove 86 is formed with the boundary of the adjoining micro grooves which protrudes and forms a protrusion. The protrusion of the bottom of the strip groove 86 extends in the circumferential direction.

An explanation will be given of how to form the stripe grooves 86.

(1) A member to be formed with the dynamic pressure generating grooves 50 or 54 is chucked to, as a work-piece, the spindle of a processing machinery, and is turned around the rotation axis R.

(2) A bite to form the micro grooves is caused to abut the surface of the turning work-piece which is formed with the grooves . At this time, the tip of the bite is alternately vibrated in the radial direction of the work-piece at a predetermined timing. Hence, the micro groove 88 and a portion that does not form a groove are alternately and continuously formed in the circumferential direction.

(3) Next, the relative position between the work-piece and the bite in the axial direction is changed by a predetermined distance (pitch) to form another micro groove 88. According to this operation, the two micro grooves 88 extending in the circumferential direction are formed so as to be arranged side by side in the axial direction and to have respective portions overlapping with each other in the axial direction.

(4) Subsequently, other micro grooves 88 are repeatedly formed to form the multiple micro grooves 88 extending in the circumferential direction and arranged side by side in the axial direction. The adjoining micro grooves 88 have respective portions overlapping with each other in the axial direction. Consequently, the stripe groove 86 is formed as a set of the multiple micro grooves 88 having respective portions overlapping with each other in the axial direction and arranged side by side in the axial direction. By forming each of the stripe grooves 86 as a set of the micro grooves 88, the groove width and the groove depth can be changed optionally at the end portion of the stripe groove 86 and at the center portion thereof.

As another example, the dynamic pressure generating grooves 50 and 54 can be formed by other techniques, such as pressing, ball rolling, electrolytic etching (electro chemical machining), and cutting and machining.

### Holding Structure

The bearing mechanism 52 includes a holding structure that holds the lubrication fluid in a gap between the bearing body 8 and the shaft body 6, and, a sealing structure that suppress a leakage of the lubrication fluid. The holding structure includes a gap between the top flange 12 and the shaft encircling member 42, a gap in the radial direction between the shaft encircling member 42 and the shaft 110, a gap between the shaft encircling member 42 and the flange part 16, and a fluid passage BP. The sealing structure may include a tapered space which is in communication with the holding structure, and which increases the width toward the exterior. In particular, the bearing mechanism 52 includes a first tapered space 124 and a second tapered space 122 both of which are in communication with the holding structure. In other words, the first tapered space 124 and the second tapered space 122 are each a space having the gap decreased toward the interior of the holding structure.

### First Tapered Space

The gap in the radial direction between the outer circumference of the top flange 12 and the inner circumference of the outer cylinder part 136 form the first tapered space 124 that is formed in a tapered shape which gradually increases a width upwardly in the axial direction. An external wall of the first tapered space 124 and an internal wall thereof contact a first gas-liquid interface LB1 that functions as a capillary seal (sometimes called a tapered seal) which suppresses a leak-out of the lubricant 20 by capillary force.

### Second Tapered Space

The gap in the radial direction between the outer circumference of the shaft encircling member 42 and the inner circumference of the flange encircling part 18 form the second tapered space 122 that is formed in a tapered shape which gradually increases a width upwardly in the axial direction. An external wall of the second tapered space 122 and an internal wall thereof contact a second gas-liquid interface LB2 that functions as a capillary seal which suppress a leak-out of the lubricant 20 by capillary force. At least either the first tapered space 124 or the second tapered space 122 may be provided at a different location, and may extend in the radial direction.

### Lubricant

The bearing mechanism 52 holds the lubricant 20 in the holding structure as the lubrication fluid. In particular, the lubricant 20 is applied in the holding structure, and is continuously present from the first gas-liquid interface LB1 to the second gas-liquid interface LB2. The lubricant 20 is applied through an applicator nozzle by a predetermined amount to at least either the first tapered space 124 or the second tapered space 122. The applied lubricant 20 permeates a gap in the holding structure by a capillary phenomenon, and is transferred to a predetermined area. The lubricant 20 may be forcibly transferred by returning the atmospheric pressure to the normal pressure.

The lubricant 20 contains a fluorescent material in a base oil, and when the lubricant 20 is leaking from a gap between respective members, such a leakage can be easily detected by emitting light with a predetermined wavelength.

### Fluid Passage

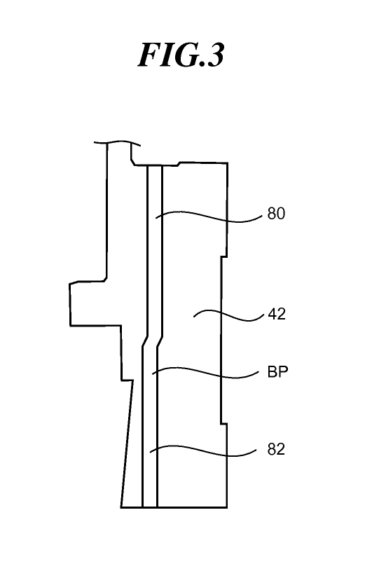

The fluid passage BP is provided in at least either the bearing body 8 and the shaft body 6 of the bearing mechanism 52. The fluid passage BP is provided so as to extend in the axial direction at a location outwardly in the radial direction relative to the dynamic pressure generating grooves 50 in the shaft encircling member 42. FIG. 3 is a cross-sectional view illustrating the shaft encircling member 42 and the fluid passage BP both in FIG. 2. The fluid passage BP allows two spaces formed at the upper-end side of the shaft encircling member 42 and at the lower-end side thereof to be in communication with each other, thereby improving a pressure difference therebetween. The fluid passage BP is provided so as to bypass the dynamic pressure generating grooves 50, 54. The fluid passage BP includes a first hole 80 that is formed in the axial direction from the upper end face of the shaft encircling member 42, and a second hole 82 which is formed in the axial direction from the lower end face of the shaft encircling member 42, and which is in communication with the first hole 80. The first hole 80 and the second hole 82 are both formed by, for example, drilling. The first hole 80 has a center located at the different position from the center of the second hole 82. In particular, the first hole 80 has the center located inwardly in the radial direction relative to the center of the second hole 82.

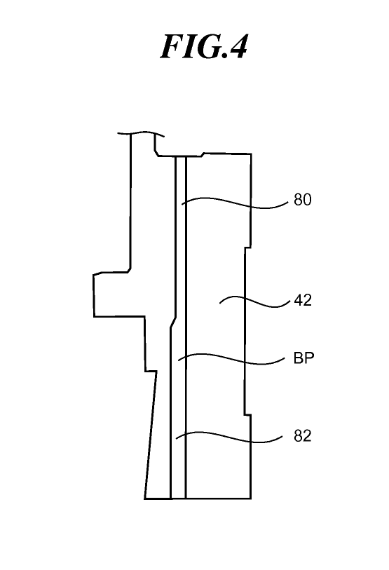

FIG. 4 illustrates a modified example of the fluid passage BP that has the first hole 80 with a different diameter from that of the second hole 82.

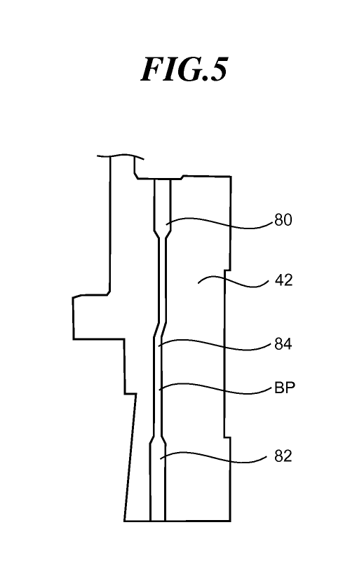

FIG. 5 illustrates the other modified example of the fluid passage BP that includes a third hole 84 which connects the first hole 80 with the second hole 82. In particular, the third hole 84 has a smaller diameter than the first hole 80 and the second hole 82, and includes a bent part in the halfway. The third hole 84 may be formed linearly.

### Bearing Mechanism

When the bearing body 8 rotates relative to the shaft body 6, the dynamic pressure generating grooves 50 and 54 generate dynamic pressure to the lubricant 20. This dynamic pressure supports the rotating body 4 connected with the bearing body 8 in a non-contact condition with the stationary body 2 connected with the shaft body 6 in the radial direction and in the axial direction.

### Bearing Stay

The bearing mechanism 52 has one end portion in the axial direction fixed to the top cover 22, and has the other end portion fixed to the chassis 24. In particular, the bearing mechanism 52 has the shaft ring 120 fitted in the bearing hole 24D, and is bonded and fixed thereto. The shaft ring 120 may be fixed to the bearing hole 24D by the other techniques . The bearing mechanism 52 has the flange encircling part 18 bonded and fixed to the annular part of the stator core 32. The bearing mechanism 52 may be not fixed to the stator core 32.

### Cap

The bearing mechanism 52 includes the cap 132 that covers at least a part of the gap between the bearing body 8 and the shaft body 6. The cap 132 includes a disk part and a cylindrical part both formed in an annular shape as viewed from the top, and is formed by, for example, cutting and machining a metal material like SUS 303. The cap 132 has the disk part extending in the radial direction, and has the cylindrical part extending downwardly in the axial direction from the outer circumference of the disk part. The cap 132 has the cylindrical part engaged with the outer cylinder part 136, and is bonded and fixed to the bearing body 8. The bond that fixes the cap 132 may contain a fluorescent material. In particular, the cylindrical part of the cap 132 is placed in a space that is formed by a diameter-decreasing portion of the outer cylinder part 136 which decreases the diameter in the radial direction. The cap 132 has the disk part covering the opening of the first tapered space 124, thereby suppressing a splashing of the lubricant 20 to the disk retaining space 70. The cap 132 may be fixed to the shaft body 6 instead of the bearing body 8.

The cap 132 may be formed by the other techniques like pressing. In addition, the cap 132 may be formed of the other materials like a resin material, and by molding, etc.

Next, an explanation will be given of an operation of the disk drive device 100 employing the structure explained above. In order to rotate the magnetic recording disks 62, a three-phase drive current is caused to flow through the respective coils 30. When such a drive current flows through the coils 30, a filed magnetic field is generated along each salient pole of the stator core 32. Torque is applied to the magnet 28 by a mutual action between the field magnetic field and the magnetic fluxes of the drive magnetic polarities of the magnet 28, and thus the hub 26 and the magnetic recording disks 62 engaged therewith are rotated. While at the same time, the voice coil motor 66 swings the swing arm 64, and thus the recording/playing head moves within the swing range over the magnetic recording disk 62. The recording/playing head converts magnetic data recorded in the magnetic recording disk 62 into electrical signals, and transmits the electrical signals to an unillustrated control board, or writes data transmitted from the control board in the form of electrical signals on the magnetic recording disk 62 as magnetic data.

The disk drive device 100 of this embodiment employing the above-explained structure can accomplish the following advantages.

Since the fluid passage BP includes the first hole 80 and the second hole 82, the respective hole portions can be formed separately. Hence, the bearing span can be elongated in comparison with a case in which the passage is formed simultaneously.

Since the first hole 80 has the different center from that of the second hole 82, when the shape of the upper end portion of the shaft encircling member 42 is inconsistent with that of the lower end portion, the first hole 80 and the second hole 82 can be formed at locations in the respective end faces where holes can be easily formed. This increases the degree of freedom for the designing of the shaft encircling member 42.

According to the modified example of the fluid passage BP, the first hole 80 has the different diameter from that of the second hole 82. Hence, by making either one diameter to be larger, even if the manufacturing error between the first hole 80 and the second hole 82 is large, both holes can be easily connected.

According to the other modified example of the fluid passage BP, the fluid passage BP includes the third hole 84 which causes the first hole 80 and the second hole 82 to be in communication with each other and which has a smaller diameter. Hence, the flow resistance in the fluid passage can be increased, thereby suppressing a leak-out of the fluid.

When a large number of magnetic recording disks 62 are to be mounted, stress inwardly in the radial direction is applied to the engage part 26E, and thus the engage part 26E may be deformed. According to this embodiment, since the annular member 130 is provided, the annular member 130 countervails the inward stress. This suppresses a deformation of the engage part 26E.

Since the annular member 130 has a portion that is present in the gap in the axial direction between the chassis 24 and the magnet 28, the dimension of the annular member 130 in the radial direction can be increased.

Since the annular member 130 includes the part 130C, the part 130B, the part 130D, the part 130E, and the outer circumference part 130A, any one of those parts can be utilized for positioning.

The structure of the disk drive device according to the embodiment and the operation thereof were explained above, but those are merely examples, and the combination of the respective structural elements can be developed in various forms, and such structures are also within the scope of the present disclosure.

In the above-explained embodiment, the rotating body 4 is joined with the bearing body 8, and the shaft body 6 is joined with the stationary body 2, but the present disclosure is not limited to this structure. The rotating body 4 may be joined with the shaft body 6, and the bearing body 8 may be joined with the stationary body 2.

What is claimed is:

1. A disk drive device comprising:
a hub including a cylindrical portion with which a recording disk is to be engaged, the hub being fixed with an annular magnet;
a base that includes a support which supports a stator core including coils, and, a bottom which is integral with the support and which faces the coils in an axial direction;
a fluid bearing mechanism that supports the hub in a manner freely rotatable relative to the base; and
an annular member which is fixed to an inner circumference of the cylindrical portion of the hub and which includes a first part that is present in an area where the base and the magnet face with each other.

2. The disk drive device according to claim 1, wherein the annular member further includes an abut part that abuts the magnet.

3. The disk drive device according to claim 2, wherein the abut part protrudes from the first part in the axial direction.

4. The disk drive device according to claim 1, further comprising a magnetic yoke that is provided between the cylindrical portion and the magnet in a radial direction,
wherein the annular member further includes a second part that faces the magnetic yoke in the axial direction.

5. The disk drive device according to claim 4, wherein the second part protrudes from the first part in the axial direction.

6. The disk drive device according to claim 1, wherein an outer circumference of the annular member is engaged with a circular step provided in the cylindrical portion.

7. The disk drive device according to claim 1, wherein the annular member further includes a magnetic part.

8. The disk drive device according to claim 1, wherein the annular member further includes a part that is present between the cylindrical portion and the magnet.

9. The disk drive device according to claim 1, wherein:
the fluid bearing mechanism comprises a shaft, and an encircling member that encircles the shaft in a freely rotatable manner relative to the shaft;
a fluid dynamic pressure generating groove is provided in a circumference of either the shaft or the encircling member facing with each other in a radial direction;
a passage that extends in the axial direction is provided in the encircling member at a location outwardly in the radial direction relative to the fluid dynamic pressure generating groove;
the passage includes a first hole which is formed from a first end face of the encircling member in the axial direction, and, a second hole which is formed from a second end face of the encircling member in the axial direction; and
a diameter of the first hole is different from a diameter of the second hole.

10. The disk drive device according to claim 9, wherein a center of the first hole is offset from a center of the second hole.

11. A disk drive device comprising:
a hub including a cylindrical portion with which a recording disk is to be engaged, the hub being fixed with an annular magnet; and
an annular member that includes an annular first part fixed to an inner circumference of the cylindrical portion of the hub, and, an abut part abutting the magnet, the first part and the abut part being integral with each other.

12. The disk drive device according to claim 11, wherein the abut part protrudes from the first part in the axial direction.

13. The disk drive device according to claim 11, further comprising a magnetic yoke that is provided between the cylindrical portion and the magnet in a radial direction,
wherein the annular member further includes a second part that faces the magnetic yoke in the axial direction.

14. The disk drive device according to claim 13, wherein the second part protrudes from the first part in the axial direction.

15. The disk drive device according to claim 11, wherein an outer circumference of the annular member is engaged with a circular step provided in the cylindrical portion.

16. The disk drive device according to claim 11, wherein the annular member further includes a magnetic part.

17. The disk drive device according to claim 11, wherein the annular member further includes a part that is present between the cylindrical portion and the magnet.

18. The disk drive device according to claim 11, wherein an end face of the magnet at the annular-member side includes portions which do not contact the abut part and which are located outwardly in a radial direction relative to the abut part and inwardly in the radial direction relative to the abut part.

19. The disk drive device according to claim 11, wherein the annular member is fixed to the cylindrical portion by interference fitting.

20. The disk drive device according to claim 19, wherein a bond is applied between the annular member and the cylindrical portion.
